(19) United States
(12) Patent Application Publication
(10) Pub. No.: US 2013/0033857 A1
(43) Pub. Date: Feb. 7, 2013

(54) LED LIGHT BAR

(71) Applicants: YA-WEN LIN, Hukou (TW); CHIH-PENG HSU, Hukou (TW)

(72) Inventors: YA-WEN LIN, Hukou (TW); CHIH-PENG HSU, Hukou (TW)

(73) Assignee: ADVANCED OPTOELECTRONIC TECHNOLOGY, INC., Hsinchu Hsien (TW)

(21) Appl. No.: 13/477,076

(22) Filed: May 22, 2012

(30) Foreign Application Priority Data
Aug. 3, 2011 (CN) 201110220884.8

(51) Int. Cl. F21V 7/00; F21V 15/01

(52) U.S. Cl. 362/217.05; 362/217.1

(57) ABSTRACT

An LED light bar comprises a housing, a circuit board with a plurality of separated portions located on the housing, a plurality of LED package devices disposed on the circuit board and electrically connecting to the circuit board, and a plurality of power dispensers respectively electrically connecting to the separated portions of the circuit board. The plurality of LED package devices is divided into a plurality of groups respectively on the plurality of separated portions of the circuit board, wherein the plurality of LED package devices of each of the groups forms a closed loop. Each separated portion of the circuit board includes a metal layer on the housing, an insulating layer on the metal layer and a circuit layer on the insulating layer. Each group of the LED package devices is on a corresponding circuit layer.

### TECHNICAL FIELD

The disclosure relates to light emitting diode (LED) light bars, and more particularly to an LED light bar having a high thermal-dissipating efficiency.

### DESCRIPTION OF THE RELATED ART

LEDs have low power consumption, high efficiency, quick reaction time, long lifetime, and the absence of toxic elements such as mercury during manufacturing. Due to those advantages, traditional light sources are gradually replaced by LEDs. Many LED light bars comprise a printed circuit board (PCB) with a plurality of LED package devices disposed on the PCB. The PCB not only will include the plurality of LED package devices, but also will have an inducing current flowing into the plurality of LED package devices. Heat generated from these LED package devices can be dissipated to the exterior via the PCB. For increasing thermal-dissipating efficiency of an LED light bar, metal core PCBs (MCPCB) may replace to the traditional PCBs. A MCPCB may contain a metal substrate, an insulating layer on the metal substrate and a circuit board on the insulating layer, wherein the metal substrate enhances a thermal-dissipating efficiency of the MCPCB. However, when a large number of LED package devices are disposed on the circuit board, a huge voltage for an inducing current, which is directed into the LED package devices may be required. For taking such huge voltage, the insulating layer must have to increase a resistance to maintain the metal substrate and the circuit board electrically isolated from each other. Usually, a method to increase the resistance of the insulating layer is to increase a thickness of the insulating layer, however, this will also increase the thickness of the LED light bar and the thermal-dissipating efficiency of the LED light bar will reduce. Therefore, a newly designed LED light bar that overcomes aforementioned deficiencies is required.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

FIG. 1 is a cross section of an LED light bar in a first embodiment of the disclosure.

FIG. 2 is an enlarged diagram of an II portion of FIG. 1.

FIG. 3 is a cross section of an LED light bar in a second embodiment of the disclosure.

### DETAILED DESCRIPTION

Exemplary embodiments of the disclosure will be described with reference to the accompanying drawings.

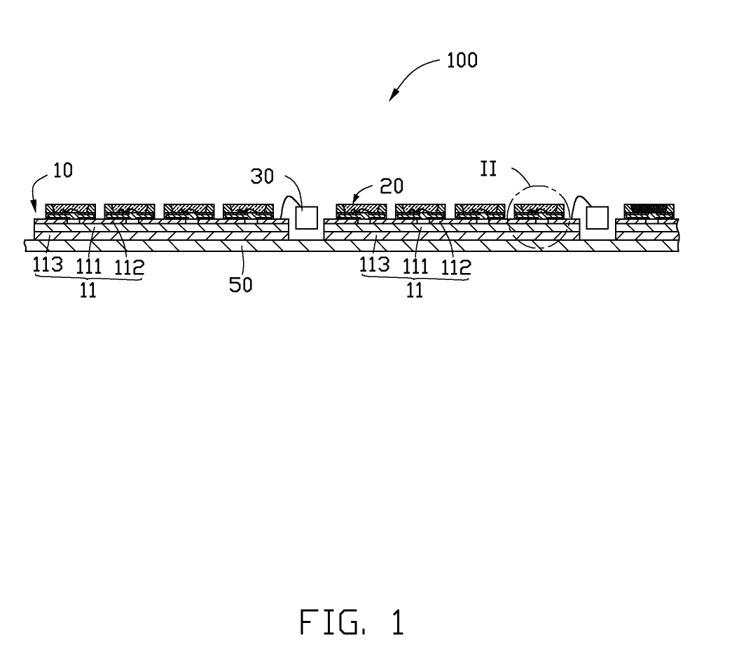

FIG. 1, of the disclosure provides a first embodiment of an LED light bar 100, which comprises a housing 50, a circuit board 10, a plurality of LED package devices 20 and at least one power dispenser 30. The circuit board 10 is located on the housing 50, and the plurality of LED package devices 20 is disposed on the circuit board 10.

The housing 50 holds the circuit board 10 and the plurality of LED package devices 20, and protects these components from external damage. In the embodiment, the housing 50 is made by plastic compounds or polymers.

The plurality of LED package devices 20 is disposed on and electrically connected to the circuit board 10, whereby an inducing current from a power supply (not shown) can flow into the plurality of LED package devices 20 via the circuit board 10. The circuit board 10 is a bar shape, and contains a plurality of separated portions. Moreover, the plurality of LED package devices 20 is divided into a plurality of groups respectively on the plurality of separated portions of the circuit board 10. In the embodiment, each of the plurality of separated portions is a MCPCB 11. Furthermore, the MCPCB 11 comprises an insulating layer 111, a circuit layer 112 and a metal layer 113, wherein the insulating layer 111 is sandwiched between the circuit layer 112 and the metal layer 113. The circuit layer 112 is composed of a plurality of electrodes separated from each other. The metal layer 113 is located on a surface of the insulating layer 111 opposite the circuit layer 112. The insulating layer 111 makes the metal layer 113 electrically disconnect from the circuit layer 112. The circuit layer 112 of each of the MCPCBs 11 forms a closed loop.

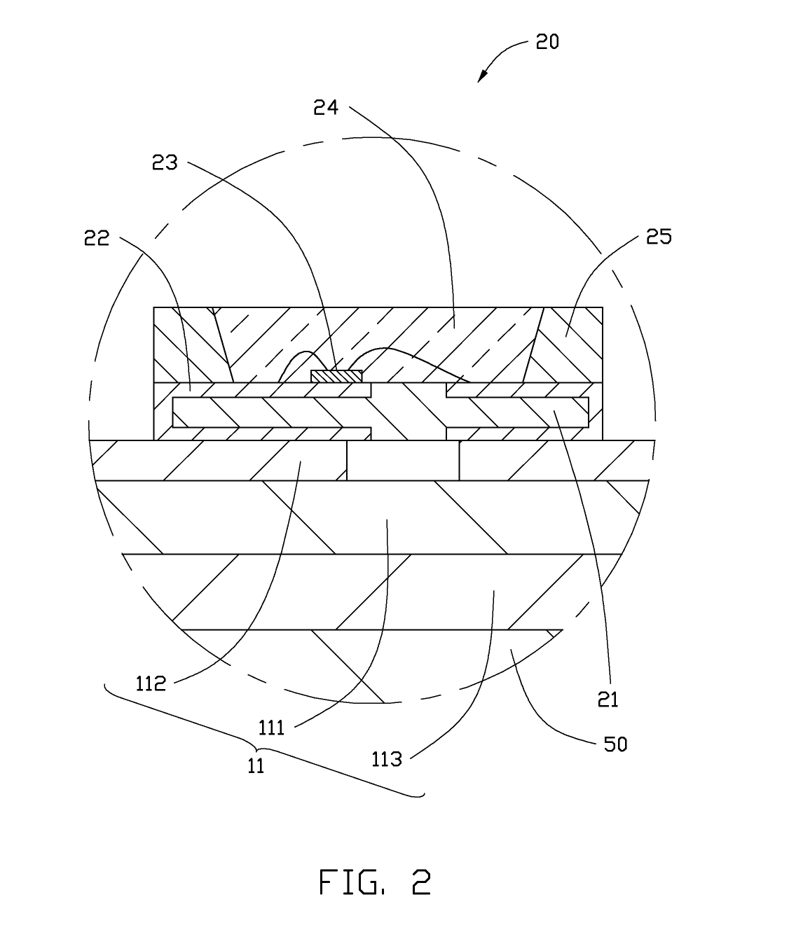

In the embodiment, there are numbers of LED package devices 20 respectively disposed on each of the MCPCBs 11. FIG. 2, shows each of the plurality of LED package devices 20 comprises a substrate 21, two pads 22 on a top surface of the substrate 21 and extending to a bottom surface opposite to the top surface, an LED chip 23 disposed on one of the two pads 23 and electrically connecting the two pads 22 via wire bonding, an encapsulation layer 24 covering the LED chip 23, and a reflector 25 surrounding the LED chip 23. The two pads 22 of each of the LED package devices 20 electrically connect to two electrodes of the circuit layer 112. Therefore, the numbers of LED package devices 20 on each of the MCPCBs 11 can make electrical-connections in series via the circuit layer 112.

The at least one power dispenser 30 electrically connects to the circuit board 10 for dispensing an electric current to the LED package devices 20. In the embodiment, there are a number of power dispensers 30 each electrically connected to a corresponding MCPCB 11. The power dispensers 30 can be electrically connected in parallel, whereby each of the MCPCBs 11 can provide a regular current to the LED package devices 20 of each of the groups.

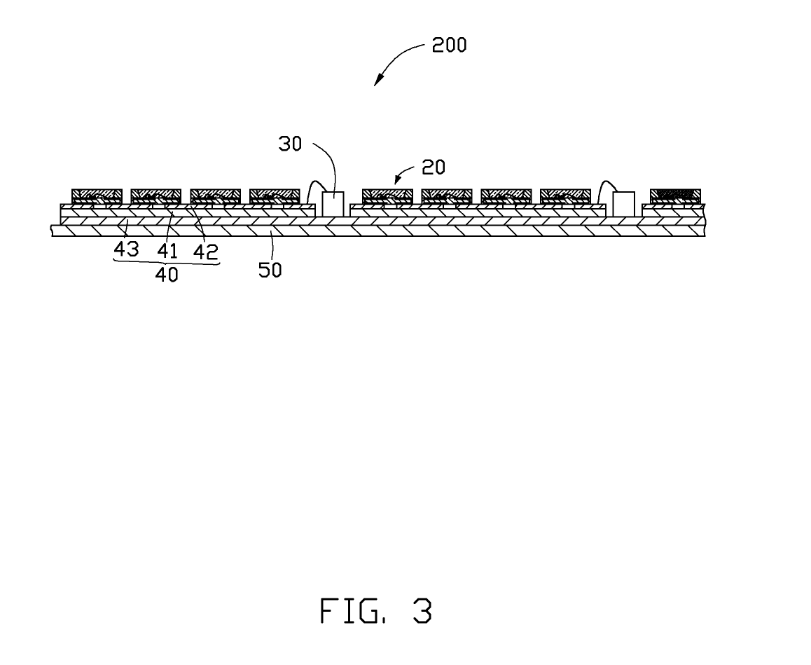

FIG. 3, of the disclosure provides a second embodiment of an LED light bar 200, which is similar to the first embodiment; the only difference is that a circuit board 40 of the LED light bar 200 has a metal layer 43 which is configured in one piece. The circuit board 40 further comprises a plurality of insulating layers 41 disposed on the metal layer 43 and a plurality of circuit layers 42 with a plurality of electrodes. Each of the circuit layers 42 is individually disposed on a corresponding insulating layer 41. Moreover, the power dispensers 30 are installed on the metal layer 43 and each are electrically connected to a corresponding circuit layer 42.

Accordingly, the plurality of LED package devices 20 is divided into a plurality of groups respectively on the plurality of separated portions of the circuit board 10 or 40, wherein the plurality of LED package devices 20 of each of the groups forms a closed loop. Even though the LED package devices 20 is increased, the thickness of the LED light bar 100 will not be increased because the LED package devices 20 are divided into a plurality of groups. In addition, a voltage of an inducing current which is directed into the circuit board 10 is dispersed and will not be enhanced. Furthermore, a thermal-dissipating efficiency of the LED light bar 100 is increased due to the thinness of the LED light bar 100.

It is to be understood, however, that even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A light emitting diode (LED) light bar, comprising:
a housing;
a circuit board with a plurality of separated portions, located on the housing, comprising a plurality of insulating layers, at least a metal layer under the plurality of insulating layers and a plurality of circuit layers each with a plurality of electrodes respectively located on the plurality of insulating layers;
a plurality of LED package devices, disposed on the circuit board and electrically connecting to the circuit layers, wherein the plurality of LED package devices is divided into a plurality of groups respectively on the plurality of separated portions of the circuit board, each group of LED package devices being mounted on and electrically connected to a corresponding circuit layer; and
at least one power dispenser, electrically connecting to the circuit board.

2. The LED light bar as claimed in claim 1, wherein the at least a metal layer comprises a plurality of metal layers isolated from each other, each insulating layer being located on and contacting with a corresponding metal layer.

3. The LED light bar as claimed in claim 1, wherein the at least a metal layer is configured in one piece.

4. The LED light bar as claimed in claim 1, wherein each group of the LED package devices forms a closed loop.

5. The LED light bar as claimed in claim 4, wherein the LED package devices of each group are electrical-connections in series.

6. The LED light bar as claimed in claim 1, wherein there are numbers of power dispensers respectively electrical-connections to the circuit layers of the circuit board.

7. The LED light bar as claimed in claim 6, wherein the numbers of power dispensers are electrical-connections in parallel.

8. The LED light bar as claimed in claim 1, wherein the LED package devices each comprise a substrate, two pads on a top surface of the substrate and extending to a bottom surface opposite to the top surface, an LED chip electrically connecting with the two pads, an encapsulation layer covering the LED chip, and a reflector surrounding the LED chip.

9. An LED light bar, comprising:
a housing;
a plurality of MCPCBs (metal core printed circuit boards), located on the housing, wherein each MCPCB comprises a metal layer, an insulating layer on the metal layer and a circuit layer with numbers of electrodes located on the insulating layer;
a plurality of LED package devices, disposed on each of the MCPCBs and electrically connecting to corresponding electrodes; and
numbers of power dispensers, respectively, electrically connecting to the MCPCBs.

10. The LED light bar as claimed in claim 9, wherein the MCPCBs are electrically isolated from each other.

11. The LED light bar as claimed in claim 9, wherein each of the MCPCBs forms a closed loop.

12. The LED light bar as claimed in claim 11, wherein the plurality of LED package devices on each of the MCPCBs is electrical-connections in series.

13. The LED light bar as claimed in claim 9, wherein the power dispensers are electrical-connections in parallel.

14. The LED light bar as claimed in claim 9, wherein each of the LED package devices comprises a substrate, two pads on a top surface of the substrate and extending to a bottom surface opposite to the top surface, an LED chip electrically connecting with the two pads, an encapsulation layer covering the LED chip, and a reflector surrounding the LED chip.

15. An LED light bar, comprising:
a housing;
a metal layer, located on the housing;
a plurality of insulating layers located on the metal layer and separate from each other;
a plurality of circuit layers respectively disposed on the plurality of insulating layers and separate from each other;
a plurality of LED package devices divided into a plurality of groups each disposed on a corresponding circuit layer and electrically connecting therewith; and
a plurality of power dispensers, located on the metal layer and, respectively, electrically connecting to the plurality of circuit layers.

16. The LED light bar as claimed in claim 15, wherein the plurality of LED package devices of the each group is electrical-connections in series.

17. The LED light bar as claimed in claim 15, wherein the power dispensers are electrical-connections in parallel.

18. The LED light bar as claimed in claim 15, wherein each of the LED package devices comprises a substrate, two pads on a top surface of the substrate and extending to a bottom surface opposite to the top surface, an LED chip electrically connecting with the two pads, an encapsulation layer covering the LED chip, and a reflector surrounding the LED chip.
